(19) United States
(12) Patent Application Publication
(10) Pub. No.: US 2002/0059386 A1
(43) Pub. Date: May 16, 2002

(54) Apparatus and method for operating toys through computer communication

(75) Inventors: Byung Ju Dan, Sungnam (KR); Jong Rak Lim, Yongin (KR); Jae Ho Na, Kuri (KR); Jang Won Boo, Seoul (KR); Hee ll Wang, Seoul (KR); Nam Woong Kim, Seoul (KR); In Sang Song, Uiwang (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 09/931,345

(22) Filed: Aug. 16, 2001

(30) Foreign Application Priority Data
Aug. 18, 2000 (KR) 2000-47833
Aug. 18, 2000 (KR) 2000-47835

(51) Int. Cl. G06F 15/16

(52) U.S. Cl. 709/206

(57) ABSTRACT

In an apparatus and a method for operating toys through a computer communication, an apparatus for operating toys through a computer communication comprises a communication server supplying message information through a computer communication in a network, an operation device interpreting the message information inputted from the communication servers, and a toy being inputted the message information from the operation device and performing a certain motion or outputting character information/audio information/image information corresponded to the inputted message information, accordingly a user can perform a computer communication with reality and have better interaction between users.

### BACKGROUND OF THE INVENTION

1. Field of the Invention

The present invention relates to operation of toys, and in particular to an apparatus and a method for operating toys through a computer communication which is capable of performing a certain motion and/or speaking a certain word by message information supplied through the computer communication.

2. Description of the Prior Art

Generally, learning/growing type toys are intelligent type toys having a program which is capable of reacting to a user's order using a remote control function or a voice recognition function. For example, the learning/growing type toys are programmed to perform an interactive operation corresponded to a user's order through a voice, a sound, a light and a contact. In more detail, the toys are programmed to grow in the intelligent and functional aspects by reacting to a user's order on an offline state and to perform a motion and/or speaking a word corresponded to the user's order.

In addition, as depicted in FIG. 1, a computer communication means a system capable of transmitting/receiving message information such as a character/image/motion picture, etc. between communication servers 10, 12 and computers 11, 13 of users connected to networks, an electronic mail and a chatting belong to the computer communication.

For example, an electronic mail is transmitted through an electronic mail server connected to a network. In more detail, in order to transmit message information to the other party, a user writes a message, accesses to the network, selects an item of a mail service, designates an ID number of the other party and transmits the message.

In addition, a chatting means transmitting/receiving message information using a key board through a chatting server connected to the network in order to communicate interactively on a screen. However, recently, not only a character based chatting but also a chatting added image information and audio information have been developed, and a user can perform a chatting in a cyber space such as a MUD (Multi-User Dimension) copying a real world by using a virtual character representing the user.

However, because the above-mentioned conventional computer communication technology simply transmits information such as character, image, motion picture, etc., it can not induce the user to perform a computer communication interactively and to have continuous interest.

### SUMMARY OF THE INVENTION

Accordingly, it is an object of the present invention to provide an apparatus and a method for operating toys through a computer communication which are capable of making a user perform a computer communication with reality and have better interaction in a computer communication by making toys perform a certain motion or speak a certain word by using an operation file or a preset keyword, etc. provided through a computer communication.

In order to achieve the above-mentioned object, the apparatus for operating a toy through a computer communication includes a communication server providing message information through a computer communication on a network, an operation device interpreting the message information inputted from the communication server, and a toy being inputted the message information from the operation device and performing a certain motion or outputting character information/image information corresponded to the inputted message information.

In order to achieve the above-mentioned object, the method for operating a toy through a computer communication includes judging whether message information is received through a computer communication, interpreting the received message information, judging whether there is a designated message information in the interpreted message information, and making the toy perform a motion or speak a word by operating a toy operation software when there is the designated message information.

### BRIEF DESCRIPTION OF THE DRAWINGS

FIG. 1 is a block diagram illustrating the conventional computer communication system.

FIG. 2 is a block diagram illustrating a computer communication system in accordance with the present invention.

FIG. 3 is a block diagram illustrating an interactive operation of each construction part of a toy in accordance with the present invention.

FIG. 4 is a flow chart illustrating a method for operating a toy through a computer communication in accordance with the present invention.

FIG. 5 is a block diagram illustrating an electronic mail system for operating a toy in accordance with the present invention.

FIG. 6 is an exemplary illustration illustrating a construction of an electronic mail in accordance with a first embodiment of the present invention.

FIG. 7 is an exemplary illustration illustrating a construction of a script language in accordance with the present invention.

FIG. 8 is an exemplary illustration illustrating a construction of an electronic mail in accordance with a second embodiment of the present invention.

FIG. 9 is an exemplary illustration illustrating a construction of a motion/audio database in accordance with the present invention.

FIG. 10 is an exemplary illustration illustrating using a certain keyword in a first embodiment of the present invention.

FIG. 11 is an exemplary illustration illustrating a construction of an electronic mail in accordance with a third embodiment of the present invention.

FIG. 12 is an exemplary illustration illustrating a construction of an accompanying execution file in accordance with the present invention.

FIG. 13 is a flow chart illustrating an electronic mail system for operating a toy in accordance with the present invention.

FIG. 14 is a block diagram illustrating a chatting system for operating a toy in accordance with the present invention.

FIG. 15 is a flow chart illustrating operation of a toy using a certain key word in accordance with the present invention.

FIG. 16 is an exemplary illustration illustrating a conversational window displaying a certain key words in accordance with the present invention.

FIG. 17 is an exemplary illustration illustrating a certain script language in accordance with the present invention.

FIG. 18 is an exemplary illustration illustrating a conversational window displaying special characters in accordance with the present invention.

FIGS. 19 and 20 are flow charts illustrating interactive operation of a virtual character and a toy when a user chats in a cyber space with the virtual character in a network.

### DETAILED DESCRIPTION OF THE PREFERRED EMBODIMENT

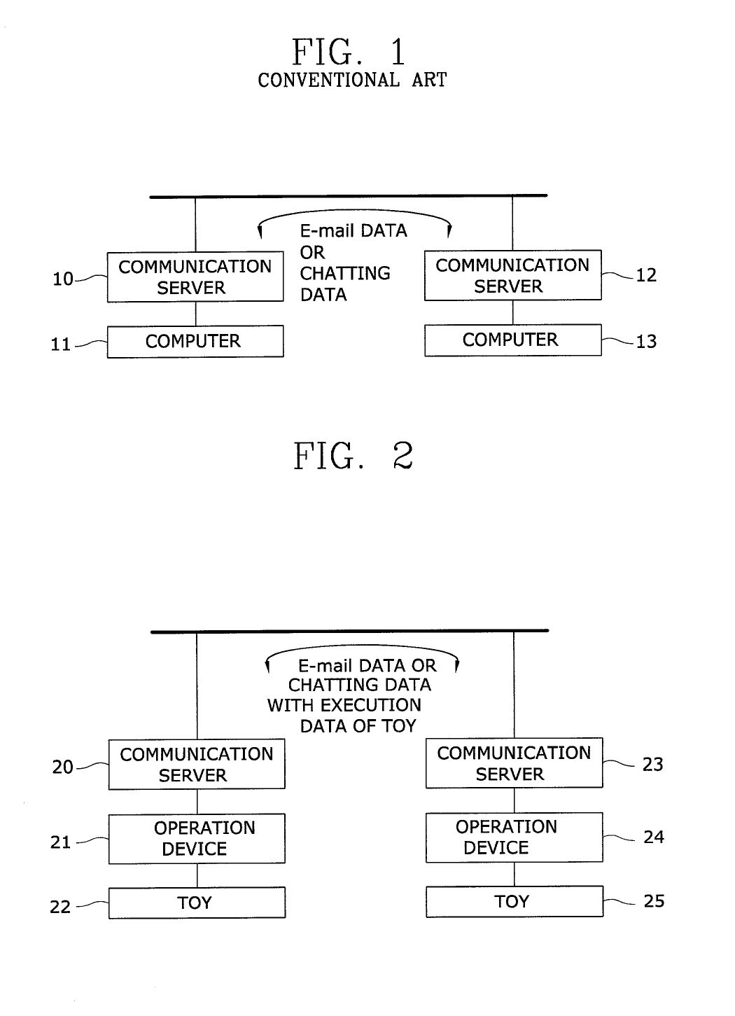

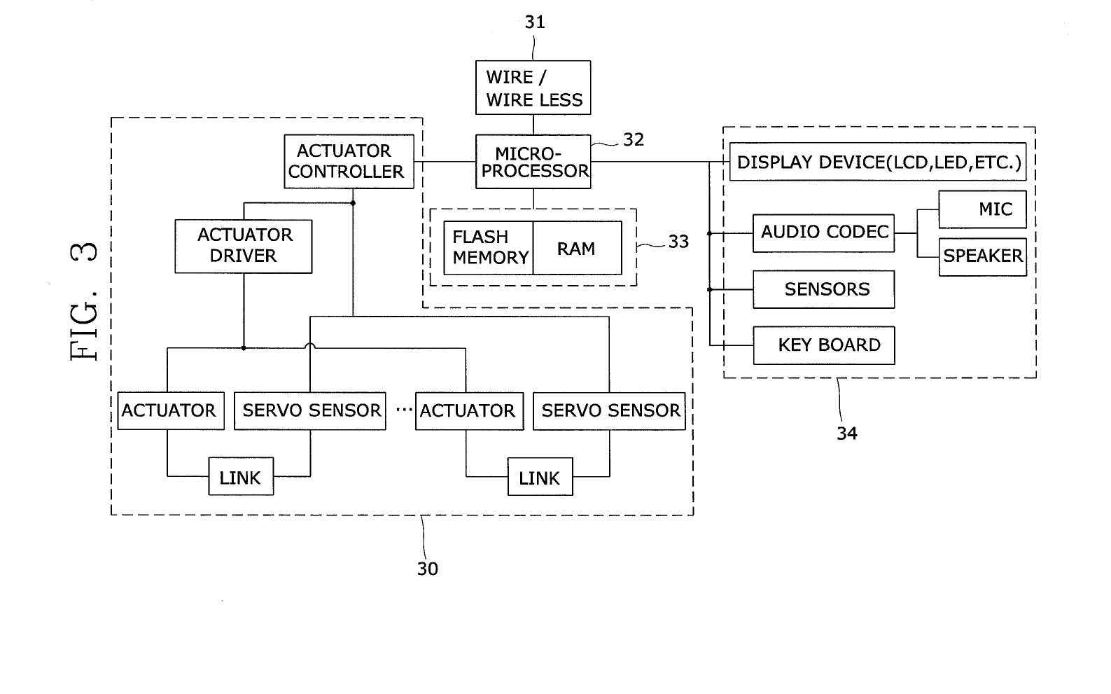

FIG. 2 is a block diagram illustrating a computer communication system in accordance with the present invention. As depicted in FIG. 2, an apparatus for operating toys through a computer communication includes communication servers 20, 23 supplying message information through a computer communication in a network, operation devices 21, 24 interpreting the message information inputted from the communication servers 20, 23, and toys 22, 25 being inputted the message information from the operation devices 21, 24 and performing a certain motion or outputting character information/audio information/image information corresponded to the inputted message information.

Herein, the communication servers 20, 23 can be chatting servers receiving/transmitting message information between users chatting in the network or electronic mail servers receiving/transmitting message information between users mailing in the network.

The operation devices 21, 24 are computers or mobile phones or PDAs having a wire-wireless communication function for supplying message information to the toys 22, 25 or the communication servers 20, 23 and further include a virtual character performing motions or speaking words in a cyber space by being inputted message information supplied from the communication servers 20, 23. In addition, in a computer communication using the virtual character, the virtual character performs motions interactive with an actual toy.

As depicted in FIG. 3, the toys 22, 25 includes respectively a memory means 33 storing message information or memorizing information acquired through learning, an input/output means 34 inputting or outputting character information, audio information or video information, a wire-wireless communication means 31 constructed with a PC or a mobile phone or a PDA for transmitting/receiving the character information, audio information or video information, a microprocessor 32 calculating a variation or an angle of a toy in order to operate a toy, and an operating unit 30 operating the toy by using a value calculated in the microprocessor 32. Accordingly, the toys 22, 25 can directly connect to the communication servers 20, 23 and receive/transmit message information without passing through the operation devices 21, 24. Herein, the memory means 33 can obtain a certain motion information, character information, audio information, image information by storing a motion/audio database constructed with motion, action, operation of the power, voice, music, audio, character and pattern and combination thereof.

In addition, the input/output means 34 includes a keyboard, a microphone, a sensor for inputting message information and a display unit, a speaker outputting the inputted message information.

In the meantime, because the toys 22, 25 store information related to operation by a certain keyword or an execution file included in an electronic mail in an additional memory region, when a user selects a certain keyword in a web browser, the user can construct sequentially all actions or languages or images corresponded to the certain keyword. In this case, the user can operate the toy by extracting a certain keyword or an operation file transmitted from a certain client.

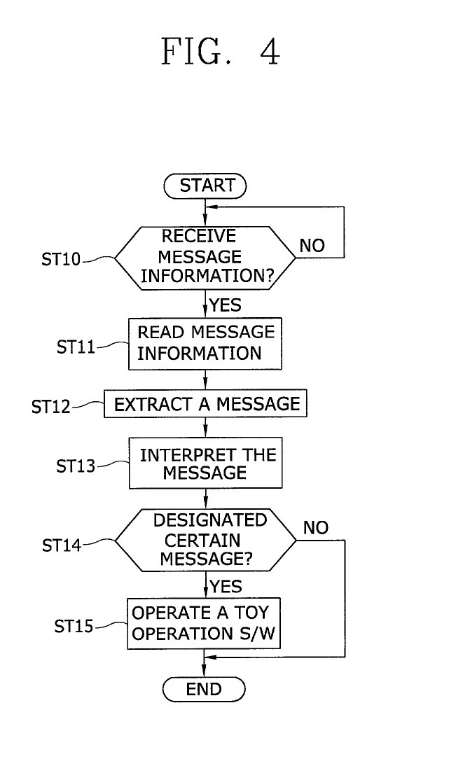

FIG. 4 is a flow chart illustrating a method for operating a toy through a computer communication in accordance with the present invention. As depicted in FIG. 4, it is judged whether message information is received through a computer communication as shown at step ST10, when the message information is received, the received message is extracted and interpreted as shown at steps ST11-ST13, it is judged whether there is a certain designated message information in the interpreted message information, when there is the certain designated message information, a motion or a voice operation is performed by operating a toy operation software according to the certain designated message information as shown at steps ST14-ST15.

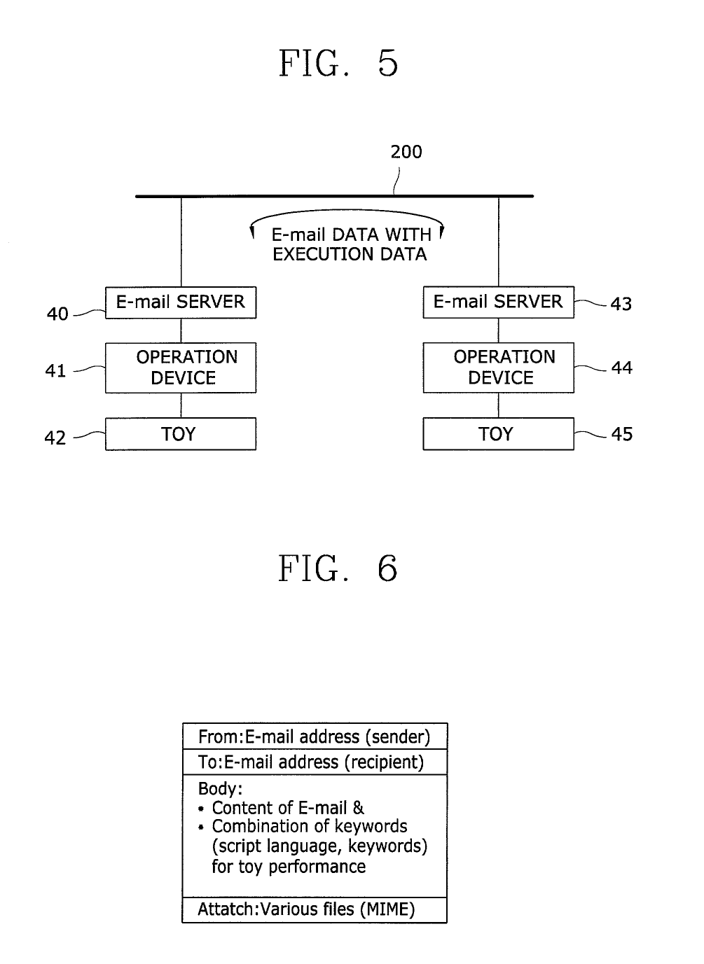

FIG. 5 is a block diagram illustrating an electronic mail system for operating a toy in accordance with the present invention. As depicted in FIG. 5, a system for operating toys through a computer communication includes electronic mail servers 40, 43 supplying message information through an electronic mail in a network, operation devices 41, 44 interpreting the message information inputted from the electronic mail servers 40, 43, and toys 42, 45 being inputted the message information from the operation devices 41, 44 and performing a certain motion or outputting character information/audio information/image information corresponded to the inputted message information.

As depicted in FIG. 6, the electronic mail is constructed with an electronic mail address of a sender and a recipient, a body part corresponded to content to be transmitted having a text based keyword, a script language having a designated format or combination thereof, and an accompanying file added information having various formats.

Accordingly, when the electronic mail having the above-mentioned construction is transmitted from the electronic mail servers 40, 43 to the operation devices 41, 44, and the user can operate the toys 42, 45.

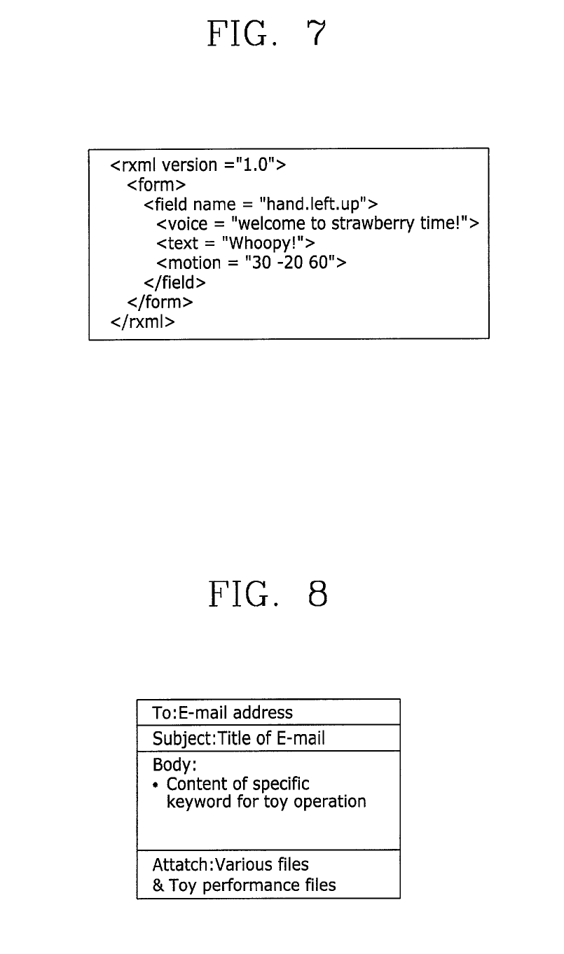

For example, a method for operating toys with the script language of the electronic mail will be described. As depicted in FIG. 7, a file constructed with the script language is transmitted to the toys 42, 45, the toys 42, 45 raises a left hand with a audio (word) as “welcome to strawberry time!” and a text as “whoopy” is displayed in a display unit.

Herein, the script defines the combination of the motion and the audio (word) as a field of “hand.left.up”, “30-2-60” in the motion part means the angle of rotation joints of the left arm, “whoopy” in the text part means picture information displayed on the display unit (for example, LCD, CRT, LED, etc.) installed to the toy.

By using the script language, motion/action/transmission of power/audio/sound/picture/character/pattern can be displayed.

In addition, as depicted in FIG. 8, the user can operate the toys 42, 45 with a certain keyword (text) of an electronic mail.

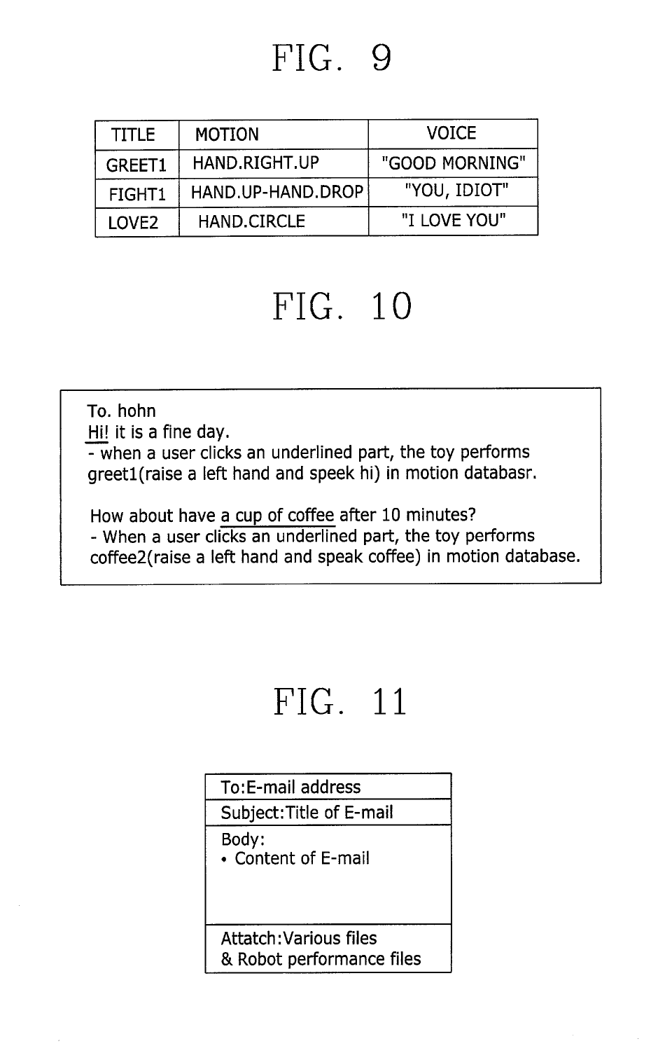

In the above-mentioned electronic mail type, when the text is displayed, certain keyword included in a body part of the electronic mail is checked whether it matches with a motion/audio database of the toy, and a certain text interactive with the toys 42, 45 is notified to the user. Accordingly, when the user clicks the certain text, the operation devices 41, 44 transmit a pertinent text to the toys 42, 45, and the toys 42, 45 search the text in the motion/audio database and performs a pertinent function. Herein, the motion/audio database includes motion, action, operation of the power, voice, music, audio, character and pattern or combination thereof. The construction is described in FIG. 9.

Accordingly, the toys 42, 45 speak the certain word and at the same time perform the motion (raising or rotating a right hand/left hand).

For example, as depicted in FIG. 10, when an electronic mail is received, if the user clicks a “hi!” part while watching the electronic mail, the toys 42, 45 search the motion/audio database and perform a greet1 (raising the left hand and speaking “hi”, if the user clicks a “a cup of coffee”, the toys search the motion/audio database and perform a coffee2 (raising the left hand toward its lip and speaking “coffee”).

FIG. 11 is an exemplary illustration illustrating a construction of an electronic mail in accordance with a third embodiment of the present invention, as depicted in FIG. 11, in the electronic mail, an execution file for executing motion and sound of the toy is provided as an accompanying file format having a MIME (Multipurpose Internet Mail Extensions) format.

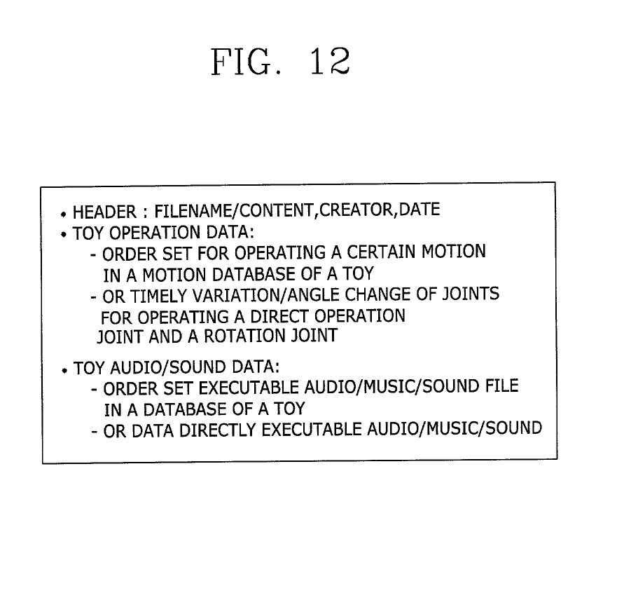

In more detail, as depicted in FIG. 12, the accompanying file having the MIME format includes a header having a file name, content, a creator and a date, toy operation data having an order set operating a certain motion of the motion database of the toys 42, 45 or timely variation/angle change data of joints operable a direct operation joint and a rotation joint, and a toy audio/sound data having an order set operating audio/music/sound file database of the toys 42, 45 or data directly executing audio/music/sound.

Accordingly, when a commercial advisement is obtained by combining the text based keyword, the designated script language, the accompanying file having the MIME format or combination thereof, by operating the toys 42, 45 according to the contents of the commercial advertisement, publicity of a company can be enhanced, and in addition, when a news/weather/stock information is obtained, it can appeal to viewers with reality.

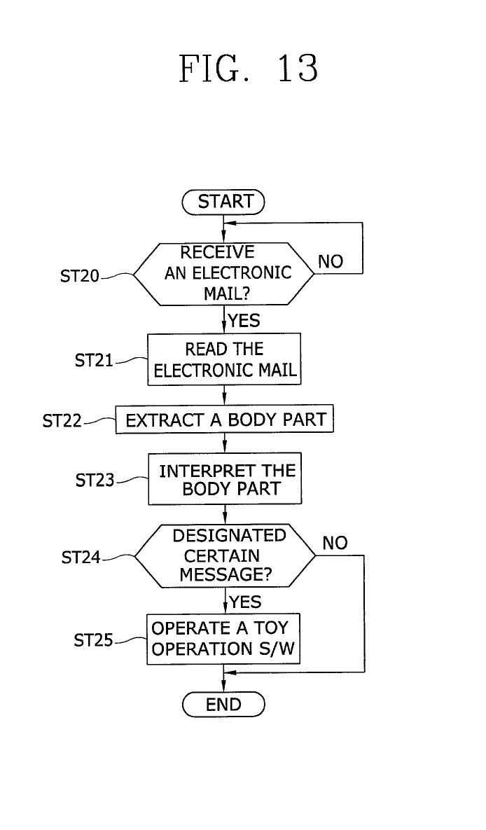

FIG. 13 is a flow chart illustrating an electronic mail system for operating a toy in accordance with the present invention. As depicted in FIG. 13, it includes judging whether an electronic mail is received as shown at step ST20, interpreting message information of the electronic mail when the electronic mail is received as shown at steps ST21-ST23, judging whether there is designated certain message information in the interpreted electronic mail information as shown at step ST24, and performing motion/audio by operating a toy operation software of the toys 42, 45 according to the certain message information when there is the designated certain message information as shown at step ST25.

In more detail, when the electronic mail information is the script language of the message information described in FIG. 7, content included in the body part is interpreted, it is judged whether the script for operating the toys 42, 45 exists, the operation devices 41, 44 transmit information to the toys 42, 45, accordingly the toys 42, 45 operate.

And, when message information of the electronic mail is the keyword described in FIG. 10, the toys 42, 45 receiving the keyword from the operation devices 41, 44 read an order corresponded to the certain keyword from the motion/audio database of the toys 42, 45 and perform a pertinent motion.

And, when message information of the electronic mail is the accompanying file in FIG. 9, it is judged whether there is the accompanying file by interpreting the content included in the body unit. Herein, when there is the accompanying file, the operation devices 41, 44 extract the accompanying file, interpret the header part and judge whether the accompanying file is an execution file for operating the toys 42, 45. Accordingly, when the accompanying file is the execution file for operating the toys 42, 45, the operation devices 41, 44 transmit the execution file to the toys 42, 45, and the toys 42, 45 read an order from the motion/audio database and perform the pertinent operation.

In the meantime, when the toys 42, 45 include an input/output means for inputting or outputting message information and a wire-wireless communication means, the toys 42, 45 can directly write an electronic mail and transmit or receive the electronic mail to the electronic mail servers 40, 43. Accordingly, the toys 42, 45 can operate independently by the certain message information such as the script language, keyword, execution accompanying file extracted and interpreted from the electronic mail supplied directly from the electronic mail servers 40, 42.

In addition, the toys 42, 45 can be obtained as virtual characters (AVATAR) performing the operation same as the actual toys in a communication means such as a computer, a mobile phone and a PDA.

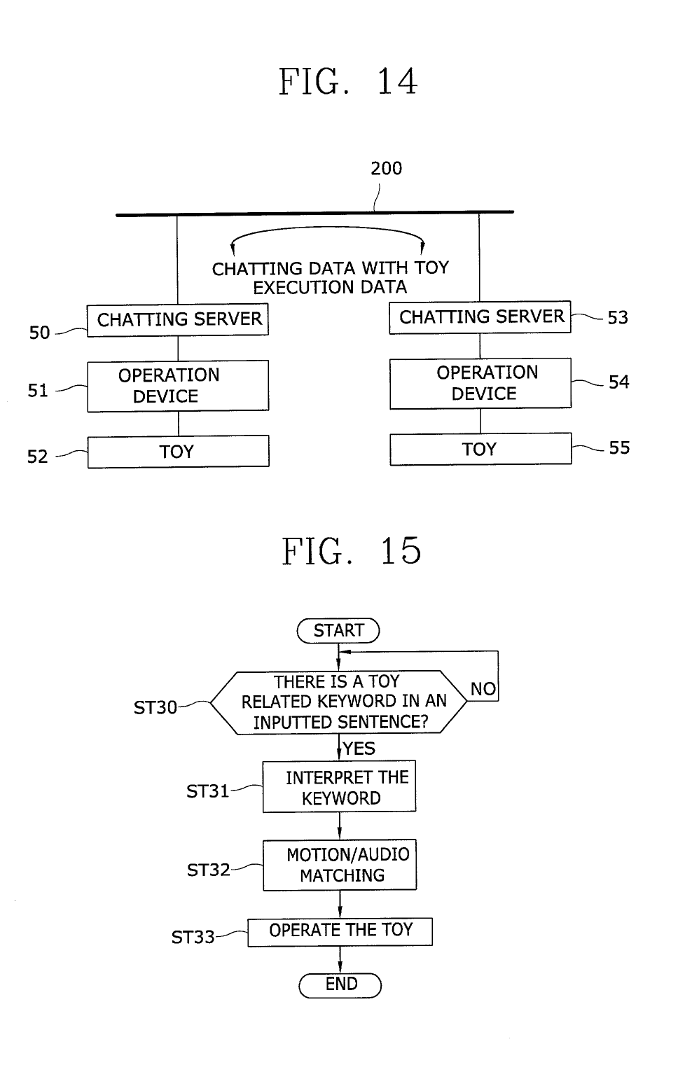

FIG. 14 is a block diagram illustrating a chatting system for operating a toy in accordance with the present invention. As depicted in FIG. 14, the chatting system includes chatting servers 50, 53 supplying message information through a chatting in a network, operation devices 51, 54 interpreting the message information inputted from the chatting servers 20, 23, and toys 52, 55 being inputted the message information from the operation devices 51, 54 and performing a certain motion or outputting character information/audio information/image information corresponded to the inputted message information.

FIG. 15 is a flow chart illustrating operation of a toy using a certain keyword in accordance with the present invention. As depicted in FIG. 15, it includes judging whether a certain keyword exists in an inputted sentence as shown at step ST30, interpreting and supplying the certain keyword to the toys 52, 55 when the certain keyword exists as shown at step ST31, and operating the toys 52, 55 by matching the pertinent motion/audio in the motion/audio database of the toys 52, 55.

In more detail, the user chats through the chatting servers 50, 53 by executing a chatting software in the operation devices 51, 54. Herein, when there is the designated certain keyword, special character or script language in the inputted message, the chatting software of the operation devices 51, 54 detect it.

Accordingly, the chatting software interprets the designated keyword, special character or script language and checks the motion/audio database whether it includes the designated keyword, special character or script language. After, by supplying the information to the toys 52, 55 and mating the motion/audio, the designated certain motion/audio is performed.

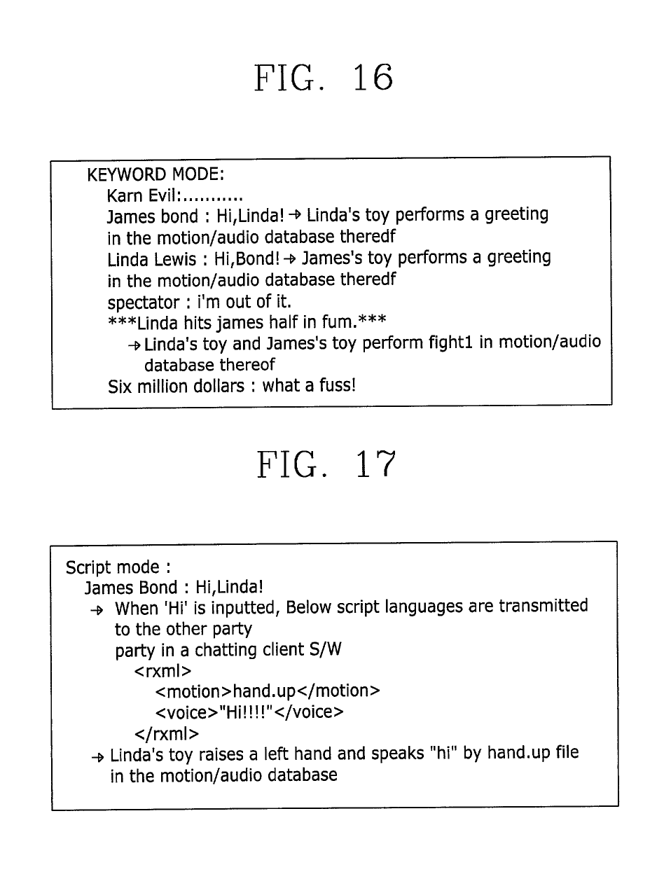

In addition, FIG. 16 is an exemplary illustration illustrating a conversational display window displaying a certain keywords in accordance with the present invention, as depicted in FIG. 16, there is a method for operating the toys 52, 55 by using a certain key word included in a chatting.

In the method, the toys 52, 55 of the other party designated in a chatting message perform a designated motion and output a greeting corresponded to a certain keyword as “hi”, the toys of the rest participants do not correspond to the certain keyword.

In addition, FIG. 17 is an exemplary illustration illustrating a certain script language in accordance with the present invention, as depicted in FIG. 17, there is a method for operating the toys 52, 55 by using the script language included in the chatting.

In the method, when the script language is transmitted from the operation device to the another communication unit, the chatting software of the operation device interprets the script language and operates the toys 52, 55.

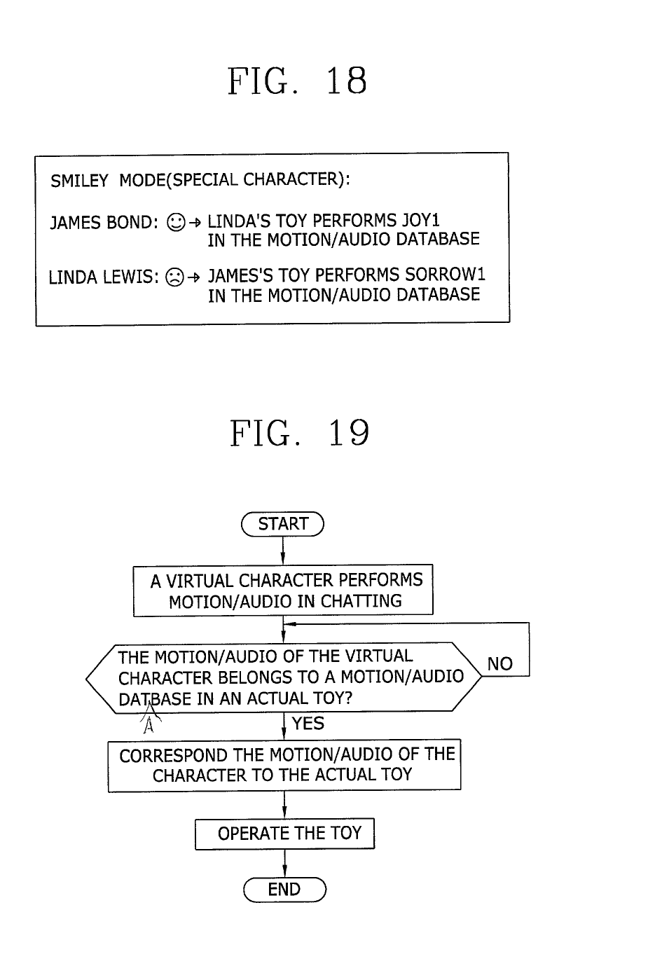

In addition, FIG. 18 is an exemplary illustration illustrating a conversational window displaying special characters in accordance with the present invention, as depicted in FIG. 18, there is a method for operating toys 52, 55 by using the special character included in the chatting.

In the method, when a smiley face is transmitted to both operation devices, the toys corresponded to the operation devices perform the designated motion/audio.

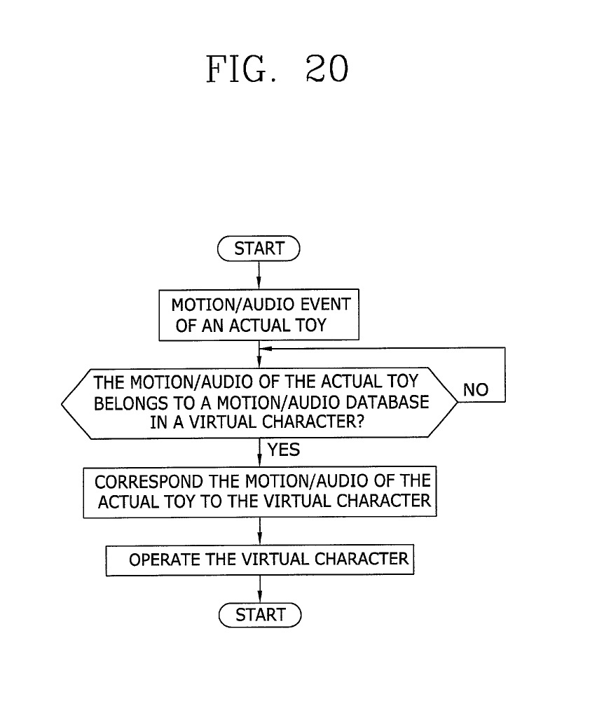

FIGS. 19 and 20 are flow charts illustrating interactive operation of a virtual character and a toy when a user chats in a cyber space in a network with the virtual character, as depicted in FIGS. 19 and 20, the operation devices 51, 54 are connected to the toys 52, 55 by wire or wirelessly, if a message is inputted to the operation devices 51, 54, the virtual character in the cyber space performs the motion/audio corresponded to the input message.

Herein, the chatting software of the operation device judges whether the motion/audio performed by the virtual character is included in the motion/audio database of the toys 52, 55.

When the motion/audio exists in the motion/audio database of the toys 52, 55, it is transmitted to toys 52, 55, accordingly the toys 52, 55 perform the motion/audio corresponded to the motion/audio of the virtual character.

On the contrary, when message information is transmitted from the other party, when there is the certain keyword or special character or designated script language in the message information, the user operate the toys 52, 55 to perform the motion/audio corresponded to the message information.

Herein, the chatting software of the operation devices 51, 54 judges whether the motion/audio performed by the toys 52, 55 exists in the motion/audio database of the virtual character.

According to this, when the motion/audio performed by the toys 52, 55 exists in the motion/audio database of the virtual character, the chatting software of the operation devices 51, 54 match the motion/audio to the virtual character and operates the virtual character to perform the motion/audio corresponded to the motion/audio of the toys 52, 55.

As described above, the apparatus and method for operating toys through a computer communication such as an electronic mail or a chatting in accordance with the present invention is capable of enhancing relations and interest of users by adding information having a certain format operable a toy of the other party.

The apparatus and method for operating toys through a computer communication such as an electronic mail or a chatting in accordance with the present invention is capable of publicizing a company by making a commercial advertisement of the company with a certain keyword, script language, execution file or combination there of and sending the commercial advertisement to clients through a computer communication such as an electronic mail or a chatting.

In addition, by applying the apparatus and method for operating toys through a computer communication such as an electronic mail or a chatting in accordance with the present invention to a mailing list service of a certain IP site, toys operate while casting information of an electronic mail such as a news/weather/stock information, accordingly the electronic mail can appeal to users with reality.

What is claimed is:

1. An apparatus for operating toys through a computer communication, comprising:
a communication server supplying message information through a computer communication in a network;
an operation device interpreting the message information inputted from the communication server; and
a toy being inputted the message information from the operation device and performing a certain motion or outputting character information/audio information/image information corresponded to the inputted message information.

2. The apparatus of claim 1, wherein the communication server is an electronic mail server supplying message information interactively between users through electronic mails in the network.

3. The apparatus of claim 2, wherein the message information includes:
an electronic mail address of a sender and a recipient;
a body part corresponded to a content to be transmitted having a text based keyword, a script language having a designated format or a combination thereof; and
an accompanying file added information having various formats.

4. The apparatus of claim 2, wherein the message information uses the designated script language of the electronic mail message information.

5. The apparatus of claim 2, wherein the message information uses the designated keyword of the electronic mail message information.

6. The apparatus of claim 2, wherein the message information uses a designated execution file having a MIME (Multipurpose Internet Mail Extensions) type accompanying file format of the electronic mail message information.

7. The apparatus of claim 6, wherein the MIME type accompanying file includes:
a header having a file name, content, a creator and a date;
toy operation data having an order set operating a certain motion of the motion database of the toy or timely variation/angle change data of joints operable a direct operation joint and a rotation joint; and
toy audio/sound data having an order set operating audio/music/sound database of a toy or data directly executable audio/music/sound.

8. The apparatus of claim 2, wherein the message information uses a combination of the designated script language, keyword, execution files having the accompanying file format of the electronic mail message information in the operation of the toy.

9. The apparatus of claim 1, wherein the communication server is a chatting server supplying message information between users through a chatting in the network.

10. The apparatus of claim 9, wherein the message information uses a designated keyword of the chatting information.

11. The apparatus of claim 9, wherein the message information uses the designated script language of the chatting information in the operation of the toy.

12. The apparatus of claim 9, wherein the message information uses the designated special character of the chatting information in the operation of the toy.

13. The apparatus of claim 9, wherein the message information uses a combination of the designated script language, the keyword, the special character of the chatting information in the operation of the toy.

14. The apparatus of the claim 1, wherein the operation device is a computer or a mobile phone or a PDA having a wire-wireless communication function in order to supply message information.

15. The apparatus of claim 1, wherein the operation device includes:
a virtual character performing a motion/audio in a cyber space by being inputted message information from the communication server.

16. The apparatus of claim 15, wherein the virtual character and the actual toy operate interactively when a computer communication using the virtual character is performed.

17. The apparatus of claim 16, wherein the toy is supplied experience information of the virtual character or grows according to learning performed by a user, performs a motion and outputs character information, audio information and video information.

18. The apparatus of claim 17, wherein the toy performs motion/audio interactive with the virtual character by being inputted motion/audio information of the virtual character from the operation device or transmitting the motion/audio information thereof to the virtual character.

19. The apparatus of claim 1, wherein the toy includes:
a memory means storing message information or memorizing information acquired through learning;
an input/output means inputting or outputting character information, audio information or video information;
a wire-wireless communication means constructed with a PC or a mobile phone or a PDA for transmitting/receiving the character information, audio information or video information;
a microprocessor calculating a variation or an angle operable a toy; and
an operating unit operating the toy by using the value calculated in the microprocessor.

20. The apparatus of claim 19, wherein the toy can directly connect to the communication server without passing through the operation device and transmit and/or receive message information.

21. The apparatus of claim 19, wherein the memory means further comprises:
a motion/audio database storing a certain motions, character information, audio information and video information.

22. The apparatus of claim 19, wherein the motion/audio database is constructed with motion, action, operation of the power, voice, music, audio, character and pattern or combination thereof.

23. The apparatus of claim 19, wherein the input/output means is constructed with a keyboard, a microphone, a sensor for inputting message information and a display unit, a speaker outputting the inputted message information.

24. The apparatus of claim 19, wherein the communication means is a PC or a mobile phone or a PDA.

25. A method for operating toys through a computer communication, comprising:
judging whether message information is received through a computer communication;
extracting and interpreting the received message information;
judging whether there is a designated message information in the interpreted message information; and
performing a motion or speaking a word by operating a toy operation software when there is the designated message information.

26. A method for operating toys through a computer communication, comprising:
judging whether an electronic mail is received;
extracting and interpreting message information of the electronic mail when the electronic mail is received;
judging whether there is designated certain message information in the interpreted electronic mail information; and
performing motion/audio of the toy by operating a toy operation software of the toy according to the designated certain message information when there is the designated certain message information.

27. The method of claim 26, wherein the designated certain message information is extracted from the body part of the electronic mail message information and interpreted.

28. The method of claim 26, wherein the designated certain message information is extracted from the execution file of the electronic mail message information and interpreted.

29. A method for operating toys through a computer communication, comprising:
receiving chatting message information;
judging whether designated certain message information exists in the received chatting message;
interpreting the designated certain message information; and
performing a designated motion/audio of the toy according to the desinated certain message information.

30. The method of claim 29, wherein the designated certain message information uses a designated keyword, a script language, a special character or a combination thereof.

31. In a method for performing a chatting using a virtual character in a network, a method for operating toys through a chatting, comprising:
performing motion/audio by a virtual character;
judging whether the motion/audio of the virtual character exists in the motion/audio database of the toy; and
performing motion/audio of the toy by interacting with the virtual character when the motion/audio of the virtual character exists in the motion/audio database of the toy.

32. In a method for performing a chatting using toys having a communication means, a method for operating toys through a chatting;
performing motion/audio of the toy;
judging whether the motion/audio of the toy exists in the motion/audio database of the virtual character; and
performing motion/audio of the toy interactively when the motion/audio of the toy exists in the motion/audio of the virtual character.
